(19) United States
(12) Patent Application Publication
(10) Pub. No.: US 2026/0328132 A1
(43) Pub. Date: Oct. 22, 2026

(54) ELECTRIC TURBOCHARGER ACTUATOR COORDINATION

(71) Applicant: FCA US LLC, Auburn Hills, MI (US)

(72) Inventors: Manvinder Singh, Auburn Hills, MI (US); Andrew M Huisjen, Auburn Hills, MI (US); David A Lawrence, Auburn Hills, MI (US); Shu Wang, Auburn Hills, MI (US)

(21) Appl. No.: 19/180,874

(22) Filed: Apr. 16, 2025

(51) Int. Cl. F02B 37/18; F02B 37/14

(52) U.S. Cl. CPC F02B 37/14; F02B 37/04; F02B 37/18

(57) ABSTRACT

An electric turbocharger control system for an engine of a vehicle includes an electric turbocharger comprising a turbocharger shaft, a turbine connected to the turbocharger shaft and configured to be driven by exhaust gas energy of exhaust gas generated by the engine, a compressor connected to the turbocharger shaft and configured to increase airflow into the engine, and further comprising (i) an electric motor configured to drive the turbocharger shaft and (ii) a wastegate valve configured to selectively release the exhaust gas energy from the turbine, and a control system configured to perform a physics-based determination of whether the electric motor and the wastegate valve are both scheduled to actuate to increase or decrease the boost pressure and based on the physics-based determination, selectively clip an exhaust gas flow target for the electric turbocharger to mitigate or prevent the excess release of the exhaust gas energy.

### FIELD

The present application generally relates to electric turbochargers and, more particularly, to techniques for electric turbocharger actuator coordination.

### BACKGROUND

A turbocharger includes a turbine that is powered by the kinetic energy of exhaust gas produced by an internal combustion engine. The turbine is connected to a shaft, which is also connected to a compressor that pressurizes or forces air into the engine for increased power generation. One specific type of turbocharger is an electric turbocharger. An electric turbocharger further includes an electric motor, powered by a battery system, that drives the shaft and, in turn, the compressor. When an electric turbocharger is equipped with a wastegate valve, the wastegate valve and the electric motor must be controlled appropriately so as to not interfere with the actions of the other, which could result in decreased power, decreased efficiency, and/or increased emissions. There can also be system constraints for an electrical system of the vehicle (the electric motor, a battery system, wiring, an inverter, etc.) that can affect or limit the operability of the electric motor. Accordingly, while existing electric turbocharger control systems and methods work for their intended purpose, there exists and opportunity for improvement in the relevant art.

### SUMMARY

According to one example aspect of the invention, an electric turbocharger control system for an engine of a vehicle is presented. In one exemplary implementation, the electric turbocharger control system comprises an electric turbocharger comprising a turbocharger shaft, a turbine connected to the turbocharger shaft and configured to be driven by exhaust gas energy of exhaust gas generated by the engine, a compressor connected to the turbocharger shaft and configured to increase airflow into the engine, and further comprising (i) an electric motor configured to drive the turbocharger shaft and (ii) a wastegate valve configured to selectively release the exhaust gas energy from the turbine, and a control system configured to perform a physics-based determination of whether the electric motor and the wastegate valve are both scheduled to actuate to increase or decrease the boost pressure and, based on the physics-based determination, selectively clip an exhaust gas flow target for the electric turbocharger to mitigate or prevent the excess release of the exhaust gas energy.

In some implementations, the control system is further configured to perform the physics-based determination by determining clipped and unclipped target turbine powers based on a target compressor power corresponding to a driver torque request, wherein the clipped target turbine power is limited by constraints of an electrical system configured to power the electric turbocharger. In some implementations, the control system is further configured to perform the physics-based determination by determining clipped and unclipped target turbine pressure ratios based on the clipped and unclipped target turbine powers.

In some implementations, the control system is further configured to perform the physics-based determination by determining clipped and unclipped target turbine mass flows based on the clipped and unclipped target turbine pressure ratios. In some implementations, the control system is further configured to perform the physics-based determination by calculating a target wastegate mass flow based on the clipped and unclipped target turbine mass flows.

In some implementations, the control system is further configured to perform the physics-based determination by determining a wastegate valve orifice flow area based on the target wastegate mass flow. In some implementations, the control system is further configured to perform the physics-based determination by determining a target position for the wastegate valve to achieve the target wastegate orifice flow area. In some implementations, the control system is further configured to control a wastegate valve actuator to position the wastegate valve at the target position.

In some implementations, the control system is configured to minimize opening of the wastegate valve and maximize regenerative energy generated by the electric motor. In some implementations, the control system is configured to maximize energy delivered to the electric motor while ensuring the wastegate valve remains closed to improve transient torque response of the engine.

According to another example aspect of the invention, an electric turbocharger control method for an engine of a vehicle is presented. In one exemplary implementation, the electric turbocharger control method comprises providing an electric turbocharger comprising a turbocharger shaft, a turbine connected to the turbocharger shaft and configured to be driven by exhaust gas energy of exhaust gas generated by the engine, a compressor connected to the turbocharger shaft and configured to increase airflow into the engine, and further comprising (i) an electric motor configured to drive the turbocharger shaft and (ii) a wastegate valve configured to selectively redirect the exhaust gas energy around the turbine, performing, by a control system of the vehicle, a physics-based determination of whether the electric motor and the wastegate valve are both scheduled to actuate to increase or decrease the boost pressure, and based on the physics-based determination, selectively clipping, by the control system, an exhaust gas flow target for the electric turbocharger to mitigate or prevent the excess release of the exhaust gas energy.

In some implementations, the physics-based determination further comprises determining, by the control system, clipped and unclipped target turbine powers based on a target compressor power corresponding to a driver torque request, wherein the clipped target turbine power is limited by constraints of an electrical system configured to power the electric turbocharger. In some implementations, the physics-based determination further comprises determining, by the control system, clipped and unclipped target turbine pressure ratios based on the clipped and unclipped target turbine powers.

In some implementations, the physics-based determination further comprises determining, by the control system, clipped and unclipped target turbine mass flows based on the clipped and unclipped target turbine pressure ratios. In some implementations, the physics-based determination further comprises calculating, by the control system, a target wastegate mass flow based on the clipped and unclipped target turbine mass flows.

In some implementations, the physics-based determination further comprises determining, by the control system, a wastegate valve orifice flow area based on the target wastegate mass flow. In some implementations, the physics-based determination further comprises determining, by the control system, a target position for the wastegate valve to achieve the target wastegate orifice flow area. In some implementations, the electric turbocharger control method further comprises controlling, by the control system, a wastegate valve actuator to position the wastegate valve at the target position.

In some implementations, the electric turbocharger control method further comprises minimizing, by the control system, opening of the wastegate valve and maximizing, by the control system, regenerative energy generated by the electric motor. In some implementations, the electric turbocharger control method further comprises maximizing, by the control system, energy delivered to the electric motor and minimizing, by the control system, opening of the wastegate valve to improve transient torque response of the engine.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a diagram depicting a vehicle comprising an engine including an electric turbocharger and an example electric turbocharger control system according to the principles of the present application;

FIG. 2 is a boost logic flow diagram depicting an example method of operating an electric turbocharger engine according to the principles of the present application;

FIG. 3 is a flow diagram depicting an example method of operating the electric turbocharger engine according to the principles of the present application;

FIGS. 4A-4B are diagrams depicting an example system architecture for the electric turbocharger control system according to the principles of the present application;

FIGS. 5A-5C are plots depicting three different example coordinated electric turbocharger controls according to the principles of the present application; and

FIGS. 6A-6B are a flow diagram depicting an example coordinated control method for an electric turbocharger of an engine of a vehicle according to the principles of the present application.

### DETAILED DESCRIPTION

As previously mentioned, an electric turbocharger further includes an electric motor, powered by a battery system, that drives the shaft and, in turn, the compressor. Depending on a torque request for the electric motor of the electric turbocharger, it can operate as a conventional turbocharger (a zero torque request) or in motoring or regeneration modes (positive and negative torque requests, respectively). When an electric turbocharger is equipped with a wastegate valve, the wastegate valve and the electric motor must be controlled appropriately so as to not interfere with the actions of the other, which could result in decreased power, decreased efficiency, and/or increased emissions. There can also be system constraints for an electrical system of the vehicle (the electric motor, a battery system, wiring, an inverter, etc.) that can affect or limit the operability of the electric motor. Accordingly, while existing electric turbocharger control systems and methods work for their intended purpose, there exists and opportunity for improvement in the relevant art.

These conventional or existing turbocharger “boost control” techniques will now be discussed in greater detail. Boost control aims to achieve an engine airflow demand (based on a driver's torque request) via positioning of a wastegate valve, which selectively opens to relieve exhaust pressure and thereby regulate the exhaust gas energy or “boost” of the turbocharger. The wastegate valve position, however, must change in response to not only airflow demand changes, but also in response to changes in operating conditions when airflow demand is unchanging. Non-limiting examples of these operating conditions include ambient air temperature, compressor inlet pressure (altitude changes), exhaust gas recirculation (EGR) configuration (e.g., low pressure vs. high pressure), throttle inlet pressure (TIP) reserve, spark timing, air/fuel ratio, and exhaust gas temperature.

Conventional (non-electric) turbocharger systems perform empirical closed-loop control of the wastegate valve. For example, this could include empirical-based feed-forward control with boost pressure sensor feedback for closed-loop proportional-integral-derivative (PID) control. Empirical-based methods, however, require extensive calibration and re-calibration, such as when other features are re-calibrated (valve lift, valve timing, spark timing, etc.). These methods also heavily rely upon PID feedback due to constrained feed-forward compensation for operating condition changes. This is a slow, reactive approach in which the system waits for error and then responds. Such systems are also dependent on the engine/component configuration (EGR, scavenging, variable valve control (VVC), secondary boosting devices, lean/rich operation, etc.).

As a result, power-based turbocharger boost control techniques have been more recently presented. These techniques utilize a complete physics-based model of a turbocharger for determining wastegate valve position based on a power demand of the turbocharger, while also automatically compensating for changing engine operating conditions and states. By utilizing this model and accounting for all operating conditions and states up front, the disclosed techniques are proactive in positioning the wastegate valve as opposed to the conventional reactive positioning techniques discussed above. These techniques are also independent of the engine/component configuration. Potential benefits include decreased calibration costs and improved vehicle efficiency (performance, responsiveness, fuel economy, etc.).

As previously discussed, the control of an electric turbocharger is even more complex than the above-described conventional (non-electric) turbocharger. To reiterate, an electric turbocharger includes an electric motor, powered by a battery system, which rotates a shaft that in turn drives the compressors and the turbine. For an internal combustion engine with an electric turbocharger, there can be a complication to coordinate exhaust gas flow power with the power of the electric motor. More specifically, both the wastegate valve/system and the electric motor are actuators (inputs) that are used to control engine boost pressure. The electric motor is capable of providing extra power to help increase boost (a motoring mode) and can also absorb turbocharger power to generate electrical power (a regeneration mode). Power management of the electric motor, however, could also be limited by a state of charge (SOC) of the battery system or other electrical system constraints (maximum currents, duty cycles, etc.).

Accordingly, improved control systems and methods for electric turbochargers are presented herein. These control techniques decide how to best command the electric motor and the wastegate valve to effectively control boost pressure and to maximize performance/efficiency. The electric motor can be considered the faster actuator as it can increase or decrease the turbocharger shaft speed faster than the wastegate valve can. In addition, when the electric turbocharger is operating in the regeneration mode, its electric motor can recuperate the excess exhaust energy to charge a battery system. This is desirable as it allows for waste heat recovery through regeneration. Therefore, the electric motor is considered the primary actuator and the wastegate valve is considered the secondary actuator. By doing this, in the motoring mode, the electric motor can quickly apply torque to the turbocharger shaft to accelerate it to the target speed. Also, in the regeneration mode, the electric motor can recuperate the otherwise wasted excess exhaust energy to recharge the battery system.

In the case of an increase in the engine torque request, the electric turbocharger should operate in the motoring mode by having the electric motor apply positive power to the turbocharger shaft to accelerate it to a higher speed. For this operating condition, the wastegate valve must be fully-closed to allow the exhaust gas energy to work together with the electric motor power to accelerate the turbocharger shaft. In the case of a decrease in the engine torque request, the electric turbocharger should operate in the regeneration mode, thereby recuperating excess exhaust energy using the electric motor. To do this effectively with two actuators, the wastegate valve must remain closed during the regeneration mode to ensure all exhaust energy is forced through the turbine. By doing this, the exhaust energy will be converted to rotational kinetic energy, which will then be recuperated by the regeneration process. An additional requirement of the system, however, is to effectively control the boost pressure while staying within the power limits of the electrical system (the electric motor, the battery system, wiring, an inverter, etc.). Therefore, another coordination requirement in the regeneration mode is to open the wastegate valve when the electric motor is unable to regenerate enough energy to slow the turbocharger shaft speed down to the target, due to running into a power limit, being faulted, or having a completely full battery SOC, among other reasons.

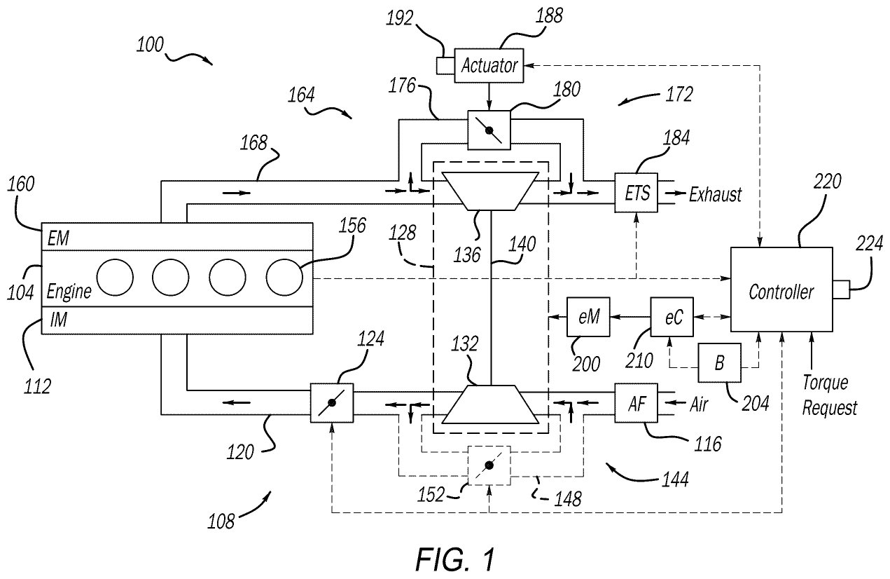

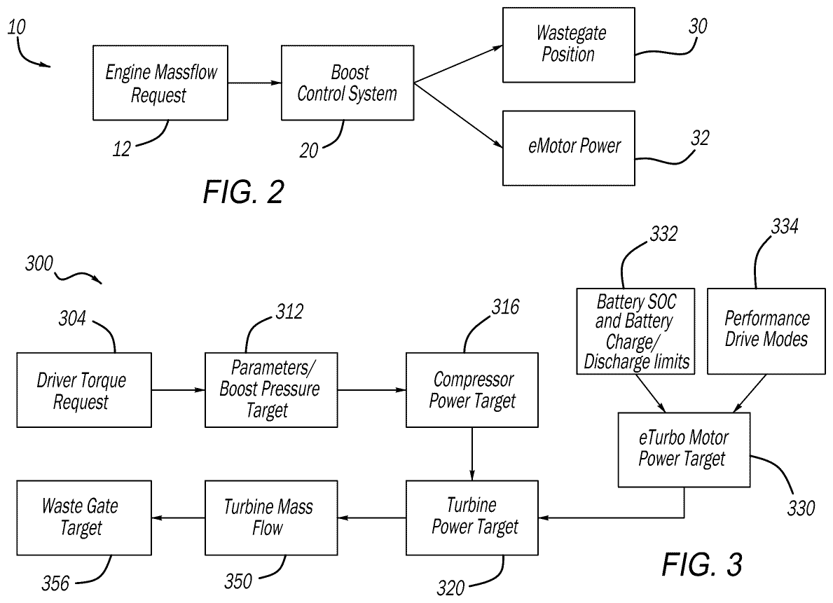

As illustrated in FIG. 2, a boost logic control flowchart 10 is shown where an engine mass flow request 12 is received by a boost control system 20. The boost control system 20 determines a wastegate position 30 and an electric motor power 32 based on the engine mass flow request. These electric turbocharger control techniques will now be discussed in greater detail with reference to FIGS. 1-5.

Referring now to FIG. 1, a diagram of vehicle 100 comprising an electric turbocharger control system according to the principles of the present application is illustrated. The vehicle 100 includes an engine 104 configured to combust an air/fuel mixture to generate drive torque. The engine 104 includes an intake system 108 that draws fresh air into an intake manifold (IM) 112 through an air filter (AF) 116 and an induction passage 120. A throttle valve 124 regulates a flow of air through the induction passage 120. A turbocharger 128 (also “electric turbocharger 128” herein) comprises a compressor 132 (e.g., a centrifugal compressor) that pressurizes or forces the air through the induction passage 120. The compressor 132 is coupled to a turbine 136 (e.g., a twin-scroll turbine) of the turbocharger 128 via a shaft 140.

The intake system 108 optionally comprises a recirculation system 144 comprising a recirculation passage 148 and a recirculation valve 152 for selectively bypassing the compressor 132. The pressurized air is distributed to a plurality of cylinders 156 and combined with fuel (e.g., from respective direct-injection or port-injection fuel injectors) to form an air/fuel mixture. While four cylinders are shown, it will be appreciated that the engine 104 could include any number of cylinders. The air/fuel mixture is compressed by pistons (not shown) within the cylinders 156 and combusted (e.g., via spark from respective spark plugs) to drive the pistons, which turn a crankshaft (not shown) to generate drive torque. The drive torque is then transferred to a driveline (not shown) of the vehicle 100, e.g., via a transmission (not shown). Exhaust gas resulting from combustion is expelled from the cylinders 156 and into an exhaust manifold (EM) 160 of the engine 104. The exhaust gas from the exhaust manifold 160 is provided to an exhaust system 164 comprising an exhaust passage 168.

Exhaust gas energy, which comprises kinetic and heat energy, drives the turbine 136, which in turn drives the compressor 132 via the shaft 140. A wastegate system 172 selectively bypasses the turbine 136 to regulate boost pressure (e.g., exhaust gas flow at an inlet of the turbine 136. The wastegate system 172 comprises a bypass passage 176 and a wastegate valve 180 that regulates the flow of exhaust gas through an orifice (e.g., the bypass passage 176). While a wastegate system 172 and a wastegate valve 180 are specifically described herein for controlling exhaust flow/energy, it will be appreciated that the techniques of the present application could also be applicable to other boost pressure regulation systems/methods, including, but not limited to, a variable geometry turbocharger having a variable geometry turbine with variable/adjustable vanes for regulating boost pressure and thereby turbine power and exhaust energy. An exhaust gas treatment system (ETS) 184, such as a catalytic converter, treats exhaust gas to decrease or eliminate emissions before it is released into the atmosphere. In one exemplary implementation, the wastegate valve 180 is electrically-actuated by an electric actuator 188 (e.g., an electric motor that displaces an arm coupled to the wastegate valve 180) that also has an associated position sensor 192.

As shown, the turbocharger 128 is configured as an electric turbocharger having an electric motor (eM) 200 that rotates the shaft 140 that in turn drives the compressor 132. The electric motor 200 is powered by a battery system (B) 204 via intermediary wiring (not shown) and an inverter (not shown), such as a three-phase half-bridge inverter, based on signals from an electric turbocharger controller (eC) 210 (also “TCM 210”). In various examples, the battery system 204 is a high voltage source, such as a 48 volt source that supplies energy for the electric motor 200 to drive the compressor 132. In other modes, the electric motor 200 can operate in a regeneration mode where rotational energy from the electric motor 200 can be used to charge the battery system 204 or deliver electric power to a transmission or axle drive motor. A powertrain controller 220 (also “PCM 220”) controls operation of the vehicle 100 and, more specifically, the engine 104 and its various components. Examples of components controlled by the controller 220 include the engine 104, the throttle valve 124, the optional recirculation valve 152, the wastegate valve 180 (e.g., via electric actuator 188), and the exhaust treatment system 184.

It will be appreciated that the controller 220 controls specific components of the vehicle 100 that are not illustrated, such as, but not limited to, fuel injectors, spark plugs, an EGR valve, a VVC system (e.g., intake/exhaust valve lift/actuation), a transmission, and the like. The controller 220 controls operation of these various components based on measured and/or modeled parameters. A set of one or more sensors 224 are configured to measure one or more parameters (pressures, temperatures, speeds, etc.) as discussed in greater detail herein. Other parameters could be modeled by the controller 220, e.g., based on other measured parameters. While separate controllers 210, 220 are shown, it will be appreciated that the electric turbocharger control techniques of the present application could be performed by a single controller or control system. For example, a control system could include the PCM 220 and the TCM 210 in communication with each other via a controller area network (CAN) or other suitable communication means.

The PCM 220 communicates parameters such as, but not limited to, a turbocharger shaft speed target, a motor speed target and a motor power limit to the TCM 210. The TCM 210 communicates parameters such as, but not limited to, a turbine speed feedback, a voltage of the battery system 204 and temperatures to the TCM 210. In this regard, the PCM 220 communicates with the TCM 210 sending speed and torque targets to the electric motor 200 and receives feedback speeds and temperatures. The battery system 204 communicates parameters such as, but not limited to, a battery SOC and a power/current limit to the TCM 210 and the PCM 220. In this regard, the battery system 204 sends battery SOC, power limits and other parameters to the PCM 220 and the TCM 210 to limit power of the electric motor 200.

Referring now to FIG. 2 and with continued reference to FIG. 1, a basic boost logic flow diagram 10 depicting an example method of operating an electric turbocharger engine according to the principles of the present application is illustrated. As shown, an engine mass flow request 12 (e.g., based on a driver torque request from an accelerator pedal) is obtained and provided to a boost control system 20, which then arbitrates or decides how to best actuate both the position of the wastegate valve 180 (wastegate position 30) and the torque/power of the electric motor 200 (electric motor power 32). As previously discussed herein, the ability to control both of these systems—i.e., the wastegate valve 180 and the electric motor 200—can be difficult as they both affect boost pressure. The electric motor power 32, for example, could be negative (regeneration mode) to maximize electrical energy recovery, subject to constraints of the battery system 204 (e.g., SOC) and other system constraints. After this point, the wastegate valve 180 must be utilized to decrease boost pressure. In contrast, the wastegate valve 180 should also not be opened/actuated while the electric motor power 32 is positive (motoring mode), as this would be energy inefficient.

Referring now to FIG. 3 and with continued reference to FIGS. 1-2, a flow diagram of an example method 300 of operating the engine 104 having the electric turbocharger 128 is illustrated. For explanatory purposes, components of the vehicle 100 will be referenced, but it will be appreciated that this method 300 could be used for any engine having an electric turbocharger. At 304, the controller 220 obtains a torque request for the engine 104. In one exemplary implementation, this torque request is based on input from a driver via an accelerator pedal. In one example, an aggressive accelerator pedal input that exceeds a threshold results in a closing of the wastegate valve 180 to achieve maximum power out of the turbine 136. The electric motor 200 is used to (immediately) drive the compressor 132 without having to wait for the exhaust energy to ramp up. At 312, the controller 220 obtains a set of parameters that each affect exhaust gas energy (i.e., the current condition(s) at the turbine inlet). At least some of the parameters of the set of parameters will be utilized for each of the calculations discussed in greater detail below.

Examples of the parameters that affect exhaust gas energy include, but are not limited to: ambient (vehicle external) temperature, barometric pressure (altitude), throttle inlet pressure, intake manifold pressure, intake manifold temperature, turbine inlet temperature, compressor inlet pressure, compressor outlet pressure, compressor inlet temperature, turbine inlet pressure, turbine outlet pressure, spark retardation, engine coolant temperature, engine speed, intake air specific heat, exhaust gas specific heat, turbine inlet density, engine mass flow, enabled/disabled status of VVC and catalyst heating, target engine mass air flow, pressure losses across inlet system component(s) (e.g., air filter 116), air/fuel ratio, and current transmission gear. These parameters could be measured by sensors 224, modeled, or some combination thereof. It will be appreciated that these are merely non-limiting examples of vehicle operating parameters and that the techniques of the present application could involves the measurement/modeling or utilization of other parameters.

The following calculations/determinations each utilize at least some of the set of parameters obtained at 312. At 312, the controller 220 determines a target mass flow (air or air/EGR) into the engine 104 (e.g., a target compressor mass flow) and a target boost for the turbocharger 128 to achieve the torque request. At 316, the controller 220 determines a target power for the compressor 132 to achieve the target engine mass flow and the target turbocharger boost. As previously mentioned, the disclosed techniques utilize a complete physics-based model of the turbocharger 128, also referred to herein as a complete turbocharger model. The target compressor power determination is determined using a compressor power model portion of this complete model. In one exemplary implementation, the compressor power model uses the following equation, along with calibrated compressor efficiency and speed maps:

$${P}_{C} = \frac{\dot{m} {c}_{p} {T}_{1 C}}{{η}_{C}} ( {PR}^{( \frac{γ - 1}{γ} )} - 1 ) , \qquad ( 1 )$$

where P_{C} is the target compressor power, \dot{m} is the target compressor mass flow (e.g., air or an air/exhaust mixture if EGR is utilized), cₚ and γ are a specific heat and a specific heat ratio of intake air, respectively, T_{1C} is a compressor inlet temperature, PR is a compressor pressure ratio, which represents a ratio between compressor outlet pressure and compressor inlet pressure (e.g., barometric pressure), optionally accounting for losses (e.g., across the air filter 116), and η_{C} represents compressor efficiency.

Using the above-referenced Equation (1), the compressor power model simultaneously computes both current and target compressor power and speed required to meet the torque request. The primary calibrations are the compressor efficiency and speed maps, which are both functions of corrected mass air flow and pressure ratio. Because the compressor 132 and the turbine 136 are coupled together via the shaft 140, it will be assumed that for a conventional turbocharger, the power demand for the compressor 132 is the same as the power demand for the turbine 136. Thus, a turbine power model portion of the complete turbocharger model utilizes the target (compressor) power along with current conditions at the inlet of the turbine 136 (e.g., the set of parameters) to compute a turbine pressure ratio and turbine mass exhaust flow to achieve the target power. At 320, the controller 220 determines the target pressure ratio based on the compressor power target 316 and an electric turbocharger motor power target 330. The electric turbocharger motor power target 330 represents the speed that the shaft 140 of the compressor is driven. The electric turbocharger motor power target 330 can depend on the turbocharger speed target which is determined using boost target/request and engine operating conditions.

The electric turbocharger motor power target 330 can additionally be at least partially based on a battery SOC and charge/discharge limits 332 of the battery system 204 as well as performance drive modes 334. Performance drive modes 334 can include various electric motor 200 speed profiles (sport mode, etc.) available and associated with performance vehicles. In some examples, if the battery SOC is close to a minimum SOC limit, the controller 210 may not provide the full allowable power to the electric turbocharger 128 as there may not be enough electrical energy to do so. The target compressor pressure ratio depends on the target engine torque. The compressor pressure ratio determines the compressor power target and the electric motor power (positive or negative) required for the compressor power. In other words, the power of the electric motor 200 and the turbine 136 is combined together to produce a total power of the compressor 132 to meet a torque request of the driver. Once the turbine power target 320 is met, the input speed of the electric motor 200 can be reduced and/or the wastegate valve 180 can be opened to further manage the system.

When the power of the electric motor 200 is positive, the battery system 204 can be discharged. When the power of the electronic motor 200 is negative, a regeneration mode is initiated and the battery system 204 can be charged. The power of the electric motor 200 is limited by the battery SOC and impacted by performance drive modes 334. At 350 the target mass exhaust flow for the turbine 136 is determined based on the target compressor power and the set of parameters. In one exemplary implementation, the turbine power model based on the following equation:

$${P}_{T} = \dot{m} {η}_{T} {c}_{p} {T}_{1 T} ( 1 - P {R}^{\frac{γ - 1}{γ}} ) , \qquad ( 2 )$$

where P_{T} is the target turbine power, \dot{m} is the target turbine mass exhaust flow, c_{P} and γ are a specific heat and a specific heat ratio of exhaust gas, respectively, nr represents turbine efficiency, T_{1T} is a turbine inlet temperature, and PR represents a turbine pressure ratio, which represents a ratio between turbine outlet and inlet pressures. Equation (2) is not used directly in the turbine power model; rather, it is the basis for a unique mathematical derivation, based on the relationship between turbine pressure ratio and power.

This derivation solves a key problem: for a given turbine power target, both the required turbine pressure ratio and the turbine mass exhaust flow are unknown, and therefore neither set point can be computed directly. The derivation results in a turbine model that consists of a turbine pressure ratio calibration map that is a function of corrected turbine power and corrected turbine speed. These maps, for example, could be calibrated versions of compressor and/or turbine speed maps provided by the turbocharger manufacturer. Using this turbine pressure ratio map, the required turbine pressure ratio can be explicitly determined, at which point determination of the turbine mass exhaust flow is straightforward using a standard turbine flow map, which is a function of the turbine pressure ratio and the corrected turbine speed. Therefore, the turbine power model comprises two primary calibrations: a turbine pressure ratio map and a turbine flow map. A noteworthy second function of this turbine power model is the computation of the current turbine pressure ratio, which is the basis for a backpressure model.

To account for the electric motor power in an electric turbocharger application, however, the turbine power equation can be broken down into multiple components. Specifically, the total turbine power P_{T} needs to be separated into a flow power term (P_{TF}) and an electric motor power term (P_{TE}). The flow power term P_{TF} is calculated the same way as Equation 2. The electric motor power term P_{TE} is the power applied to the turbocharger shaft 140, which changes sign for motoring or regeneration. That is, when motoring, P_{TE}>0 and total turbine power P_{T} increases and, when regenerating, P_{TE}<0 and total turbine power P_{T} decreases. Compressor power P_{C} and turbine power P_{T} are still balanced; however, except the electric motor power term P_{TE} is now adjusting the overall turbine power target. Thus, the new power balance is:

P_{C}=P_{T}=P_{TF}+P_{TE}→P_{C}=P_{TF}+P_{TE} (3), and

the final overall power balance is:

P_{C}−P_{TE}=P_{TF} (4).

As discussed above, for a conventional (non-electric) turbocharger, the target turbine power P_{T} from Equation (2) is corrected and sent through two surfaces to determine the exhaust gases required to flow through the turbine 136 and the wastegate valve 180, to achieve the target compressor power P_{C}.

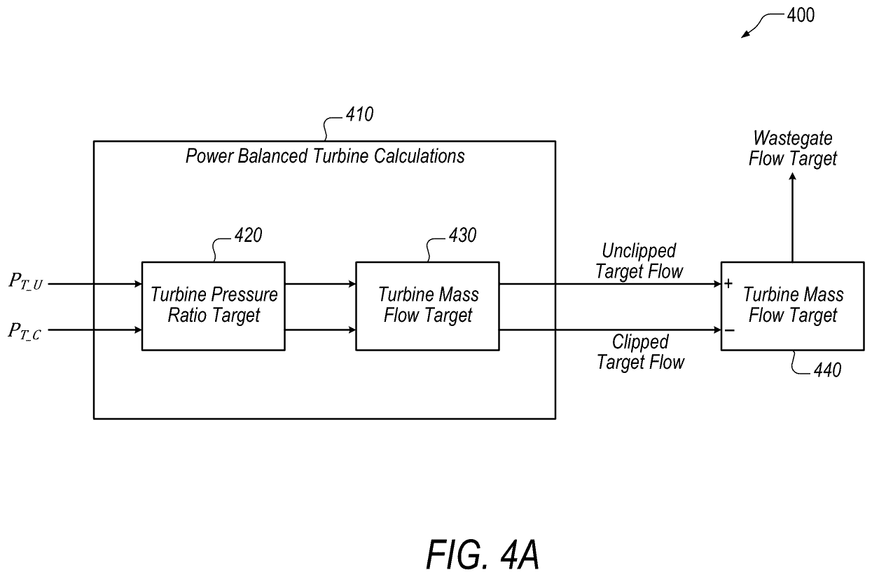

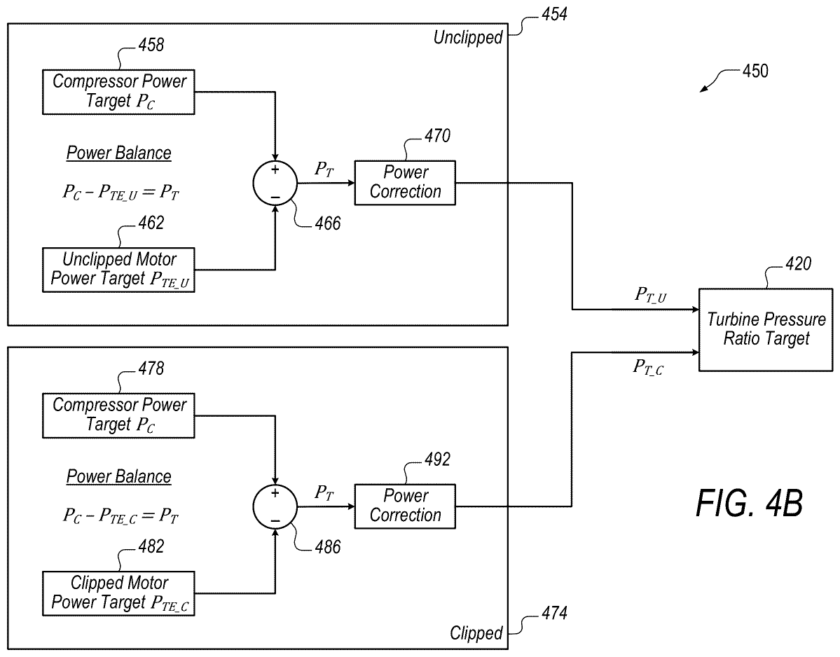

Referring now to FIGS. 4A-4B and with continued reference to the previous figures, diagrams depicting an example system architecture 400, 450 for the electric turbocharger control system according to the principles of the present application are illustrated. For an electric turbocharger application, however, the turbine calculation and the resulting wastegate flow target is calculated using two signals that propagate through the calibration surfaces. The first signal is the clipped corrected target turbine power (P_{T_C}). This signal is calculated using the new power balance Equation (4) and is shown as being utilized by blocks 410-430 of FIG. 4A. The reason this signal is referred to as a clipped signal is that the P_{TE_C} component of the clipped power calculation has a saturation limit in both the positive and negative directions, based on the capacity of the electrical system (the electric motor 200, the battery system 204, the wiring, the inverter, etc.). These saturation limits are variable and are constantly being updated based on feedback signals to the PCM 220. When the PCM 220 calculates the required electric motor power to accelerate or decelerate the turbocharger shaft 140, the signal is clipped by these upper and lower limits before it is sent or provided to the TCM 210.

Using the power balance, the clipped corrected target turbine power P_{T_C} is calculated and sent through the two calibration surfaces (blocks 420 and 430) to yield a clipped turbine flow target. This clipped corrected turbine power signal P_{T_C} is calculated as follows: P_{C}−P_{TE_C}=P_{T_C}. The second signal that propagates through the calibration surfaces is the target corrected turbine power unclipped (P_{T_U}). This signal is calculated using the same approach as the clipped signal P_{T_C} (via blocks 410-430) except that it does not have upper/lower thresholds or limits applied to the electric motor power. Thus, the resulting corrected target turbine power remains unclipped. This signal is then sent through the two calibration surfaces (blocks 420 and 430) to yield the unclipped turbine flow target. The unclipped corrected turbine power signal P_{T_U} is calculated as follows: P_{C}−P_{TE_U}=P_{T_U}. When the electric motor power request is within the upper and lower capability limits of the electrical system, both the clipped and unclipped turbine power signals P_{T_C} and P_{T_U} are the same or equal. Thus, there is no wastegate flow target and the wastegate valve 180 remains fully-closed.

At 350 and 356, the controller 220 determines a position of the wastegate valve 180 to achieve the target pressure ratio and the target mass exhaust flow for the turbine 136. This can also be described as determining the wastegate flow area (e.g., CdA) from the required wastegate/turbine mass exhaust flow split. This determination involves using a wastegate model portion of the complete turbocharger model. In one exemplary implementation, the determined position is a wastegate orifice flow area to achieve the target pressure ratio and the target mass exhaust flow for the turbine 136. This is also the point at which the physics-based features of the techniques become very clear. That is, the wastegate valve position is at its root being driven by a flow request, whereas a typical empirical system uses experimental data to estimate the physical position of the wastegate valve 180 straightaway for a fixed set of operating conditions.

In one exemplary implementation, the wastegate model utilizes the following equation:

$$CdA = \frac{\dot{m}}{ρ {PR}^{\frac{1}{γ}} \sqrt{\frac{2 R}{M W} {{T}_{O} ( \frac{γ}{γ - 1} )}^{( 1 - {PR}^{\frac{γ - 1}{γ}} )}}} , \qquad ( 5 )$$

where CdA is the required flow orifice area for the wastegate valve 180 (e.g., in mm²), \dot{m} is the wastegate mass exhaust flow, γ is the specific heat ratio of the exhaust gas, ρ represents turbine inlet density, R represents the ideal gas constant, MW represents the molecular weight of the exhaust gas, and PR is the turbine pressure ratio. By considering current and future conditions, the position of the wastegate valve 180 is optimized throughout a maneuver. For example, during a large torque request increase, the turbine flow requirement will tend to be higher than the current total exhaust port flow. In these situations, the disclosed techniques will automatically close the wastegate valve 180 fully until the total exhaust port flow accumulates and exceeds the turbine flow target, at which point the wastegate valve 180 will then open to meter or bleed off the excess exhaust gas flow.

Lastly, at 356, the controller 220 commands the wastegate valve 180 to the determined position. This determined position represents a position of the wastegate valve 180 that achieves the required flow orifice area discussed above, which is determined at 350 as illustrated. In one exemplary implementation, the controller 220 commands the electric actuator 188 to position the wastegate valve 180 at the determined position, e.g., based on feedback from position sensor 192. For example, certain positions of the electric actuator 188 could correspond to certain flow areas across the wastegate valve 180, and these relationships could be utilized to command the electric actuator 188 accordingly. After positioning the wastegate valve 180 appropriately at 356, the engine 104 is able to achieve increased efficiency and/or performance compared to typical empirical-based approaches. The method 300 then ends, but it will be appreciated that the method 300 could continually repeat during engine operation (e.g., every 10 milliseconds) to continuously optimize the position of the wastegate valve 180.

As shown in FIG. 4A, the clipped and unclipped target flows are summed at block 440 to determine a final wastegate flow target. The architecture 450 of FIG. 4B further elaborates on the specific calculations to arrive at the target clipped and unclipped powers P_{T_U} and P_{T_C} that are initially provided to block 420 of FIG. 4A. For the unclipped portion 454, a difference between the compressor power target P_{C} (block 458) and the unclipped motor power target P_{TE_U} (block 462) are calculated at difference block 466 to obtain a turbine power P_{T}, which is then corrected at block 470 to obtain the unclipped turbine power target P_{T_U}. Similarly, for the clipped portion 474, a difference between the compressor power target P_{C} (block 478) and the clipped motor power target P_{TE_C} (block 482) are calculated at difference block 486 to obtain another turbine power P_{T}, which is then corrected at block 492 to obtain the unclipped turbine power target P_{T_C}.

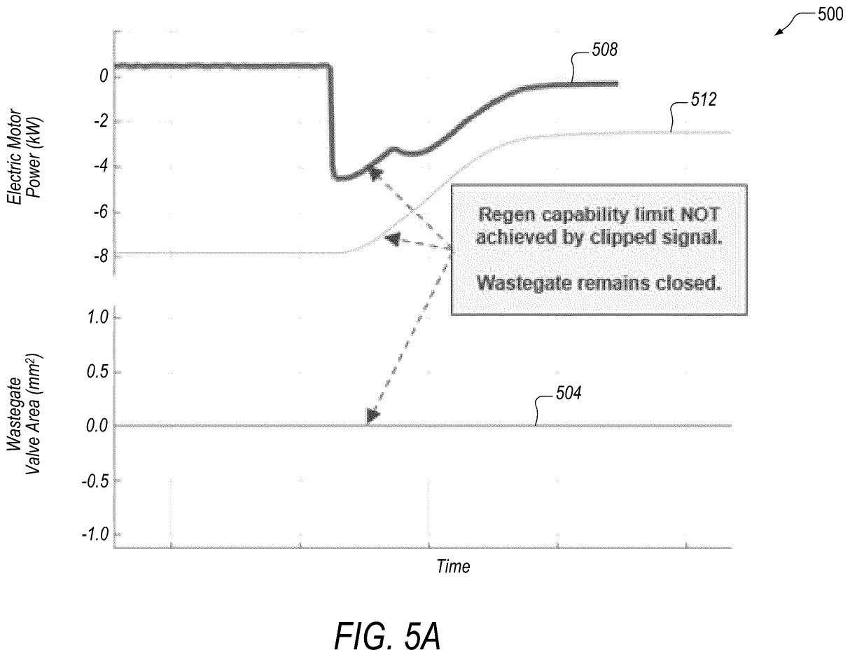

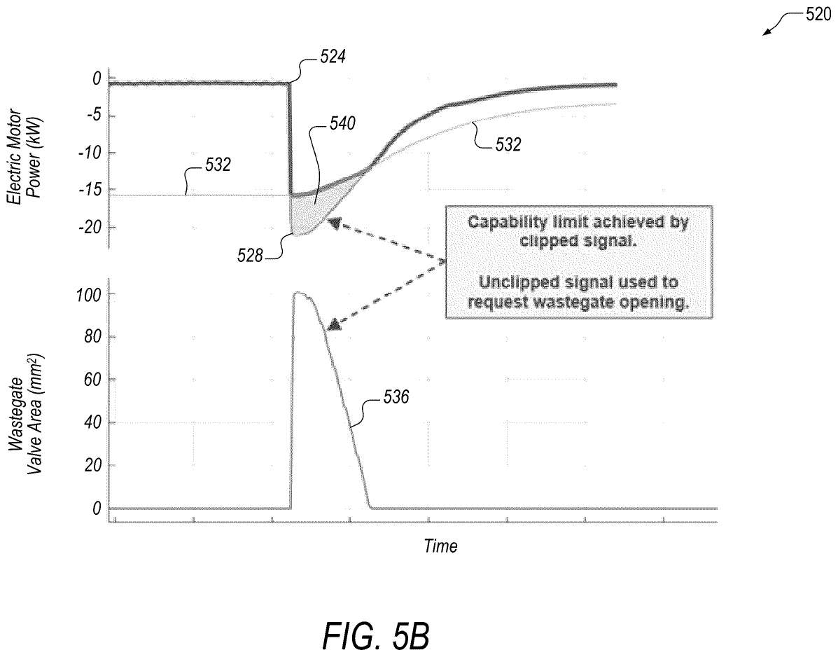

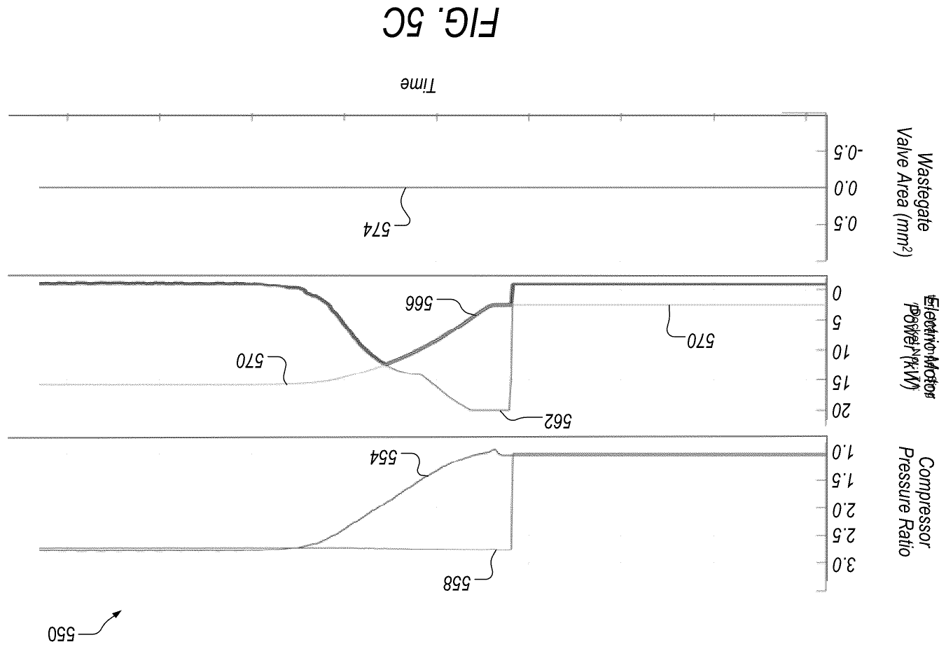

Referring now to FIGS. 5A-5C and with continued reference to the previous figures, plots 500, 520, and 550 depicting three different example coordinated electric turbocharger controls according to the principles of the present application are illustrated. The coordination is most evident in the regeneration case (FIG. 5A). For example, when the electric motor regeneration request (line 508) is within the capability limits of the high voltage battery system (line 512), the wastegate 180 remains closed (see line 504) as the clipped and unclipped signals are equal (FIG. 5A). However, if the electric motor power regeneration request (line 524) is clipped by the maximum regen capability limit (line 532), then the unclipped signal (line 528) may continue to request more theoretical regeneration (see FIG. 5B). These FIGS. 5A-5B show how the coordination priority works for the regenerative case. The clipped regen power request (line 524) is increased (more regeneration=more negative) until it reaches its maximum regen limit (line 532). While the clipped power request is above the maximum regen limit, the wastegate 180 remains closed to maximize the regen potential. After the maximum limit is achieved (see FIG. 5B), the clipped signal follows the capability limit trace, while the unclipped signal continues to request more regeneration (line 528 and region 540). When this unclipped power request exceeds the clipped power request, the unclipped turbine flow target is greater than the clipped turbine flow target. This difference is the requested flow through the wastegate 180, resulting in the wastegate opening (see line 536).

FIG. 50, on the other hand, illustrates an example plot 550 for the motoring case as opposed to the regenerative case. As shown, the engine 104 achieve its target torque when the actual compressor pressure ratio (line 554) reaches its target (line 558). For the electric motor power, the unclipped electric motor power target (line 562) exceeds the clipped electric motor power target (line 566), which are shown in reference to the capability limit (line 570). In this case, the wastegate 180 remains closed (see line 574). For example only, if the compressor power P_{C} was 5 kW and the electric motor power P_{TE_U} was 20 kW then the unclipped turbine power target P_{TU} would be 5 minus 20, or −15 kW. In this example, however, the clipped turbine energy P_{TE_C} could be 3 kW, and thus the clipped turbine power target P_{TC} would be 5 minus 3, or 2 kW. The lower power results in a lower turbine pressure ratio target and ultimately a lower turbine flow target. Thus, the wastegate flow gets clipped to zero in the saturation limit section and the wastegate 180 remains closed during the motoring condition.

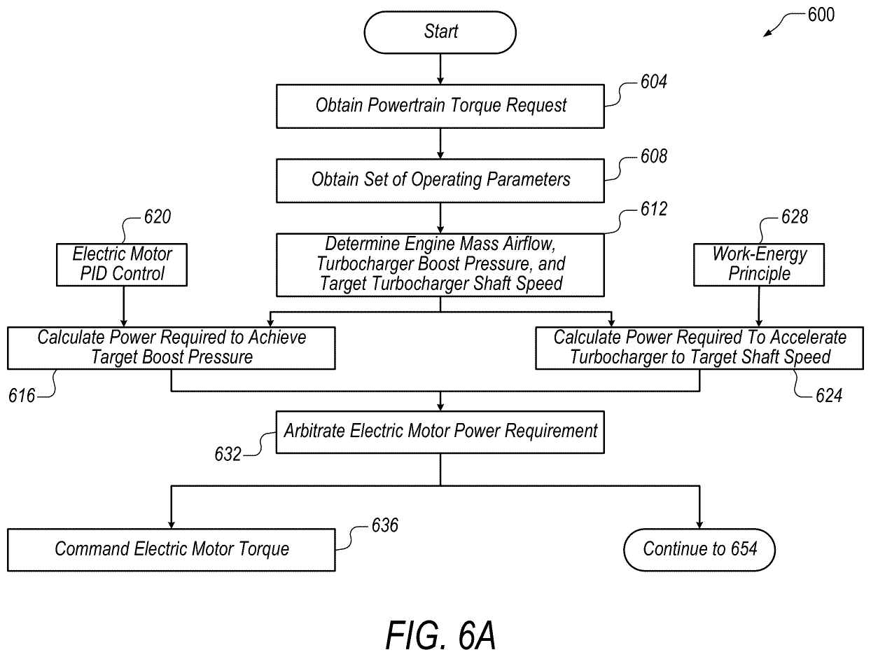

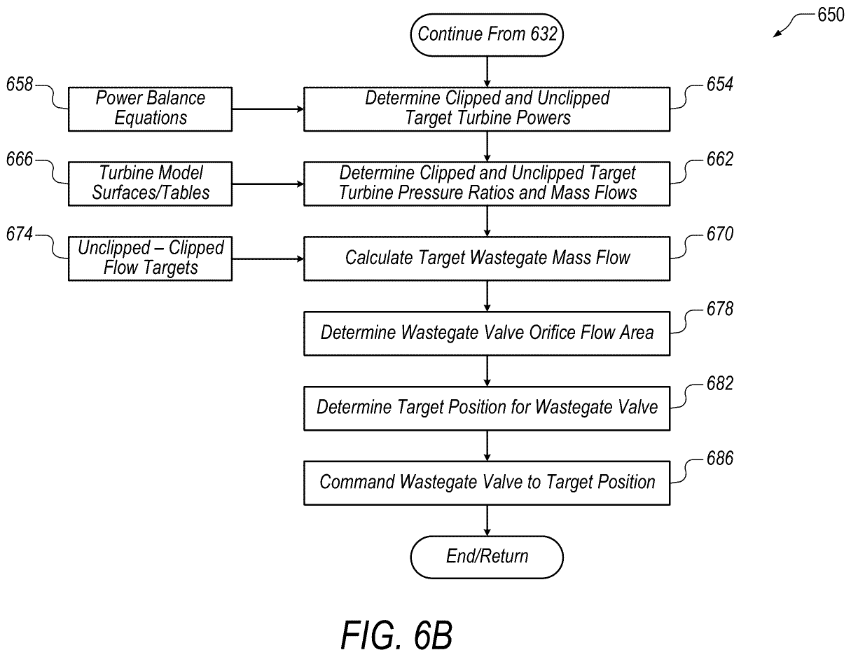

Referring now to FIGS. 6A-6B and with continued reference to the previous figures, a flow diagram depicting an example coordinated control method 600, 650 for an electric turbocharger of an engine of a vehicle according to the principles of the present application is illustrated. While the following description of these FIGS. 6A-6B specifically references components of FIGS. 1-3B (e.g., vehicle 100), it will be appreciated that the systems/methods of FIGS. 4A-6B could be applicable to any suitably equipped vehicle having an electric turbocharger. The method 600 begins at 604 where the controller 220 obtains a powertrain torque request (e.g., based on driver input). At 608, the controller 220 obtains a set of operating parameters for the vehicle 100 (e.g., from sensors 224). At 612, the controller 220 determines engine mass airflow, turbocharger boost pressure, and a target turbocharger shaft speed based on the received torque request and the operating parameter(s). The method 600 then splits into two parallel branches. In a left branch, at 616 the controller 220 calculates an electric motor power to achieve the target boost pressure based on electric motor PID control (block 620) and the method 600 continues to 632. In a right branch, at 624 the controller calculates an electric motor power required to accelerate the turbocharger shaft speed to the target value based on the work-energy principles (block 628) and the method 600 continues to 632.

At 632, the controller 220 arbitrates between these two electric motor power requirements. When satisfactory (i.e., when clipping is not required, the method 600 proceeds to 636 where the electric motor torque is commanded accordingly and the method 600 ends or returns to 604. When the arbitration at 632 indicates that clipping is required to prevent over-actuation of the wastegate 180, however, the method 600 proceeds to 654 (FIG. 6B). At 654, the controller 220 determines the clipped and unclipped target turbine powers (based on the power balance equations from 658) and as previously discussed herein. At 662, the controller 220 determines the clipped and unclipped target turbine pressure ratios and mass flows (based on the turbine model surfaces/tables from 666) and as previously discussed herein. At 670, the controller 220 calculates the target wastegate mass flow (based on the unclipped/clipped flow targets at 674) and as previously discussed herein. At 678, the controller 220 determines a wastegate valve orifice flow area as previously discussed herein. At 682, the controller 220 determines a target position for the wastegate valve 180 to achieve the wastegate valve orifice flow area. Finally, at 686, the controller 220 commands the wastegate valve 180 to the target position, thereby avoiding the wastegate valve 180 and the electric motor 200 competing with each other and wasting unnecessary energy (and potentially decreasing engine performance and increasing emissions and fuel consumption). The method 600 then ends or returns to 604.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

1. An electric turbocharger control system for an engine of a vehicle, the electric turbocharger control system comprising:
an electric turbocharger comprising a turbocharger shaft, a turbine connected to the turbocharger shaft and configured to be driven by exhaust gas energy of exhaust gas generated by the engine, a compressor connected to the turbocharger shaft and configured to increase airflow into the engine, and further comprising:
(i) an electric motor configured to drive the turbocharger shaft; and
(ii) a wastegate valve configured to selectively release the exhaust gas energy from the turbine; and
a control system configured to:
determine whether the electric motor and the wastegate valve are both scheduled to actuate to increase or decrease the boost pressure; and
when the electric motor and the wastegate valve are both scheduled to actuate:
determine a clipped and unclipped target turbine powers based on a target compressor power corresponding to a driver torque request, wherein the clipped target turbine power is limited by constraints of an electrical system configured to power the electric turbocharger, and
selectively clip an exhaust gas flow target for the electric turbocharger based on the clipped and unclipped target turbine powers.

2. (canceled)

3. The electric turbocharger control system of claim 1, wherein the control system is further configured to determine clipped and unclipped target turbine pressure ratios based on the clipped and unclipped target turbine powers.

4. The electric turbocharger control system of claim 3, wherein the control system is further configured to determine clipped and unclipped target turbine mass flows based on the clipped and unclipped target turbine pressure ratios.

5. The electric turbocharger control system of claim 4, wherein the control system is further configured to calculate a target wastegate mass flow based on the clipped and unclipped target turbine mass flows.

6. The electric turbocharger control system of claim 5, wherein the control system is further configured to determine a wastegate valve orifice flow area based on the target wastegate mass flow.

7. The electric turbocharger control system of claim 6, wherein the control system is further configured to determine a target position for the wastegate valve to achieve the target wastegate orifice flow area.

8. The electric turbocharger control system of claim 7, wherein the control system is further configured to control a wastegate valve actuator to position the wastegate valve at the target position.

9. The electric turbocharger control system of claim 1, wherein the control system is configured to minimize opening of the wastegate valve and maximize regenerative energy generated by the electric motor.

10. The electric turbocharger control system of claim 1, wherein the control system is configured to maximize energy delivered to the electric motor while ensuring the wastegate valve remains closed to improve transient torque response of the engine.

11. An electric turbocharger control method for an engine of a vehicle, the electric turbocharger control method comprising:
providing an electric turbocharger comprising a turbocharger shaft, a turbine connected to the turbocharger shaft and configured to be driven by exhaust gas energy of exhaust gas generated by the engine, a compressor connected to the turbocharger shaft and configured to increase airflow into the engine, and further comprising:
(i) an electric motor configured to drive the turbocharger shaft; and
(ii) a wastegate valve configured to selectively redirect the exhaust gas energy around the turbine;
determining, by a control system of the vehicle, whether the electric motor and the wastegate valve are both scheduled to actuate to increase or decrease the boost pressure; and
when the electric motor and the wastegate valve are both scheduled to actuate:
determining, by the control system, clipped and unclipped target turbine powers based on a target compressor power corresponding to a driver torque request, wherein the clipped target turbine power is limited by constraints of an electrical system configured to power the electric turbocharger, and
selectively clipping, by the control system, an exhaust gas flow target for the electric turbocharger based on the clipped and unclipped target turbine powers.

12. (canceled)

13. The electric turbocharger control method of claim 11, further comprising determining, by the control system, clipped and unclipped target turbine pressure ratios based on the clipped and unclipped target turbine powers.

14. The electric turbocharger control method of claim 13, further comprising determining, by the control system, clipped and unclipped target turbine mass flows based on the clipped and unclipped target turbine pressure ratios.

15. The electric turbocharger control method of claim 14, further comprising calculating, by the control system, a target wastegate mass flow based on the clipped and unclipped target turbine mass flows.

16. The electric turbocharger control method of claim 15, further comprising determining, by the control system, a wastegate valve orifice flow area based on the target wastegate mass flow.

17. The electric turbocharger control method of claim 16, further comprising determining, by the control system, a target position for the wastegate valve to achieve the target wastegate orifice flow area.

18. The electric turbocharger control method of claim 17, further comprising controlling, by the control system, a wastegate valve actuator to position the wastegate valve at the target position.

19. The electric turbocharger control method of claim 11, further comprising minimizing, by the control system, opening of the wastegate valve and maximizing, by the control system, regenerative energy generated by the electric motor.

20. The electric turbocharger control method of claim 11, further comprising maximizing, by the control system, energy delivered to the electric motor and minimizing, by the control system, opening of the wastegate valve to improve transient torque response of the engine.
